(19) United States
(12) Patent Application Publication
(10) Pub. No.: US 2023/0410210 A1
(43) Pub. Date: Dec. 21, 2023

(54) SYSTEMS AND METHODS FOR MODELING AND GENERATING SUPPLY CHAIN CONTRACTS

(71) Applicant: Scott C. Moore, Pittsburgh, PA (US)

(72) Inventor: Scott C. Moore, Pittsburgh, PA (US)

(21) Appl. No.: 18/308,851

(22) Filed: Apr. 28, 2023

Related U.S. Application Data
(60) Provisional application No. 63/342,761, filed on May 17, 2022.

(51) Int. Cl. G06Q 40/08; G06Q 30/0283; G06Q 30/08; G06Q 10/0635

(52) U.S. Cl. CPC G06Q 40/08; G06Q 10/0635; G06Q 30/08; G06Q 30/0283

(57) ABSTRACT

A computer-implemented method includes retrieving data associated with procurement of products; generating a first model training dataset for a machine-learning market module; training the market module to classify a suitability of each product for supply chain insurance; applying the market module to classify a first product of the products as suitable for supply chain insurance; generating a second model training dataset for a machine-learning contract term module; training the contract term module to determine terms of a supply chain insurance contract for the first product; applying the contract term module to determine terms of the supply chain insurance contract; presenting, on a user platform generated on a user interface, the terms of the supply chain insurance contract for the first product; receiving a user input that indicates whether the terms are agreeable; and updating the first model training dataset or the second model training dataset based on the user input.

### CROSS-REFERENCE TO RELATED APPLICATION

This application claims priority to U.S. Provisional Patent Application No. 63/342,761, filed May 17, 2022, the disclosure of which is hereby incorporated by reference herein in its entirety.

### FIELD

The present disclosure relates generally to network-based supply chain platforms and, more particularly, to systems and methods for modeling and generating supply chain contracts on a supply chain platform.

### BACKGROUND

Supply chains generally involve two or more entities that are each associated with producing, handling, delivering, and/or procuring materials. Materials move between the entities in the supply chain in order to provide a finished product to an end consumer. In its most basic form, a supply chain includes a single supplier or manufacturer that produces a finished product and a single buyer that procures the finished product. However, supply chains are typically much more complex, and may include myriad entities that each serves a discrete role within the supply chain.

In complex supply chains, logistical problems frequently arise due to an inability to produce or procure materials, partially or in whole, at one or more discrete levels of the supply chain. For example, logistical problems may arise due to shortages of raw materials, labor, and/or capital, unforeseen supply chain disruptions, surges in consumer demand for a finished product, and limits or restrictions on transportation and distribution. These problems, occurring at discrete levels of the supply chain, may have severe impacts on product availability on a larger scale. The COVID-19 pandemic highlighted the logistical challenges in complex supply chains during a major disruption event, which resulted in shortages of several consumer products (e.g., toilet paper) and crisis supplies (e.g., ventilators). Significantly, these logistical challenges included not only an inability of upstream manufacturers to produce enough of the products and supplies (collectively “products”) themselves, but also an inability of downstream entities to effectively allocate and deliver the products where needed. In this respect, the product shortages were exacerbated by challenges experienced at multiple discrete levels in the supply chain. Further, stockpiling of these products by entities within the supply chain in preparation for unforeseen disruption events may not be sufficient to effectively respond to crisis situations. Stockpiling may be further inadequate in the case of products that are at risk of spoilage or expiration, or require high storage costs, where the duration between high demand cycles of a product exceeds a lifetime of the product or otherwise creates excessively high storage costs.

Conventional network-based supply chain platforms have focused on inventory management solutions by enabling entities within a supply chain to visualize supply chain activity and anticipate product shortages and disruptions within the supply chain. Conventional platforms may implement predictive analytics and scenario modeling to determine a likelihood that logistical challenges will be experienced at one or more discrete levels of the supply chain, and may evaluate the effect that these challenges may have on inventory levels and associated economic costs to entities in the supply chain. Conventional platforms have also facilitated generating contracts between entities in the supply chain which may be based, at least in part, on predicted inventory levels and likelihood of logistical challenges. Contracts generated or otherwise facilitated by conventional platforms may be structured between two entities, or between multiple entities in a subcontract arrangement, in a way that attempts to eliminate or reduce a likelihood that inventory shortages will occur within the supply chain. In this regard, conventional platforms may generate and/or determine contract terms based on known specific and/or idiosyncratic needs and interests of the entities within the supply chain to reduce or eliminate the likelihood of inventory shortages.

However, there exist opportunities to provide services and functionality not currently offered by conventional supply chain platforms that may facilitate, for example, improving crisis preparedness in supply chains, as well as generating a new marketplace for supply chain entities to enter into, execute, and trade supply chain contracts, among other interactions.

### BRIEF SUMMARY

In one aspect, a supply chain insurance (“SCI”) computer system is provided. The SCI computer system may include at least one processor in communication with at least one memory device. The at least one processor may be programmed to: i) retrieve, from at least one database, data associated with procurement of a plurality of products, the data comprising transaction records and supply chain agreements for the plurality of products; ii) generate, from the retrieved data, a first model training dataset for a market module implemented by a machine learning engine, wherein the first model training dataset comprises transaction trends of the plurality of products; iii) train, using the first model training dataset, the market module to classify a suitability of each product for supply chain insurance based on the transaction trends; iv) apply the market module to classify a first product of the plurality of products as suitable for supply chain insurance; v) generate, from the retrieved data, a second model training dataset for a contract term module implemented by the machine learning engine, wherein the second model training dataset comprises terms of supply chain agreements for the first product; vi) train, using the second model training dataset, the contract term module to determine terms of a supply chain insurance contract for the first product; vii) apply the contract term module to determine one or more terms of the supply chain insurance contract; viii) generate a user platform on a user interface of a computing device associated with a supply chain entity, wherein the user platform presents information associated with the first product classified by the market module and the one or more terms of the supply chain insurance contract for the first product; ix) receive, from the computing device associated with the supply chain entity, a user input that indicates whether the supply chain entity is agreeable to the one or more terms of the supply chain insurance contract; and/or x) update at least one of the first model training dataset and the second model training dataset based on the user input. The SCI computer system may be configured with additional, less, or alternate functionality, including that discussed elsewhere herein.

In another aspect, at least one non-transitory computer-readable media having computer-executable instructions thereon is provided. When executed by at least one processor of an SCI computing device including and/or in communication with at least one database, the computer-executable instructions may cause the at least one processor of the SCI computing device to: i) retrieve, from the at least one database, data associated with procurement of a plurality of products, the data comprising transaction records and supply chain agreements for the plurality of products; ii) generate, from the retrieved data, a first model training dataset for a market module implemented by a machine learning engine, wherein the first model training dataset comprises transaction trends of the plurality of products; iii) train, using the first model training dataset, the market module to classify a suitability of each product for supply chain insurance based on the transaction trends; iv) apply the market module to classify a first product of the plurality of products as suitable for supply chain insurance; v) generate, from the retrieved data, a second model training dataset for a contract term module implemented by the machine learning engine, wherein the second model training dataset comprises terms of supply chain agreements for the first product; vi) train, using the second model training dataset, the contract term module to determine terms of a supply chain insurance contract for the first product; vii) apply the contract term module to determine one or more terms of the supply chain insurance contract; viii) generate a user platform on a user interface of a computing device associated with a supply chain entity, wherein the user platform presents information associated with the first product classified by the market module and the one or more terms of the supply chain insurance contract for the first product; ix) receive, from the computing device associated with the supply chain entity, a user input that indicates whether the supply chain entity is agreeable to the one or more terms of the supply chain insurance contract; and/or x) update at least one of the first model training dataset and the second model training dataset based on the user input. The instructions may direct additional, less, or alternate operations or functionality, including those discussed elsewhere herein.

In yet another aspect, a computer-implemented method is provided. The method may be implemented using an SCI computing device including at least one processor in communication with at least one memory. The method may include: i) retrieving, from the at least one database, data associated with procurement of a plurality of products, the data comprising transaction records and supply chain agreements for the plurality of products; ii) generating, from the retrieved data, a first model training dataset for a market module implemented by a machine learning engine, wherein the first model training dataset comprises transaction trends of the plurality of products; iii) training, using the first model training dataset, the market module to classify a suitability of each product for supply chain insurance based on the transaction trends; iv) applying the market module to classify a first product of the plurality of products as suitable for supply chain insurance; v) generating, from the retrieved data, a second model training dataset for a contract term module implemented by the machine learning engine, wherein the second model training dataset comprises terms of supply chain agreements for the first product; vi) training, using the second model training dataset, the contract term module to determine terms of a supply chain insurance contract for the first product; vii) applying the contract term module to determine one or more terms of the supply chain insurance contract; viii) presenting, on a user platform generated on a user interface of a computing device associated with a supply chain entity, information associated with the first product classified by the market module and the one or more terms of the supply chain insurance contract for the first product; ix) receiving, from the computing device associated with the supply chain entity, a user input that indicates whether the supply chain entity is agreeable to the one or more terms of the supply chain insurance contract; and/or x) updating at least one of the first model training dataset and the second model training dataset based on the user input. The method may include additional, less, or alternate actions, including those discussed elsewhere herein.

Advantages will become more apparent to those skilled in the art from the following description of the preferred embodiments which have been shown and described by way of illustration. As will be realized, the present embodiments may be capable of other and different embodiments, and their details are capable of modification in various respects. In addition, although certain steps of the exemplary processes are numbered, having such numbering does not indicate or imply that the steps necessarily have to be performed in the order listed. The steps may be performed in the order indicated or in another order. Accordingly, the drawings and description are to be regarded as illustrative in nature and not as restrictive.

### BRIEF DESCRIPTION OF THE DRAWINGS

The Figures described below depict various aspects of the systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and are instrumentalities shown, wherein:

FIG. 1 is a schematic diagram illustrating an exemplary computing system for implementing a supply chain insurance contract scheme.

FIG. 2 illustrates a schematic diagram of a machine learning engine executed by the computing system shown in FIG. 1 used to execute one or more machine learning algorithms or models, and optionally in communication with a user platform implemented by the computing system.

FIG. 3 illustrates an exemplary configuration of a client system that may be used in the system shown in FIG. 1, in accordance with an embodiment of the present disclosure.

FIG. 4 illustrates an exemplary configuration of a server system that may be used in the system shown in FIG. 1, in accordance with an embodiment of the present disclosure.

FIG. 5 is a schematic illustration of a user platform provided by the computing system shown in FIG. 1.

FIG. 6 is a flow chart illustrating an exemplary method for modeling and generating supply chain insurance contracts, in accordance with an embodiment of the present disclosure.

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION

The systems and methods described herein relate to, inter alia, implementing machine learning techniques for modeling and generating supply chain insurance contracts and, in some embodiments, implementing a user-interactive marketplace platform that enables supply chain entities using the platform to request, enter into, execute, and/or trade supply chain contracts. In one exemplary embodiment, the systems and methods may be implemented by a supply chain insurance (“SCI”) computer system (also referred to herein as an “SCI server”). The SCI system interfaces with client devices associated with supply chain entities via a client application such as, for example, a supply chain insurance application. The application may be a dedicated client application installed on a client device, and/or may include a web browser application on the client device that accesses one or more web pages hosted by the SCI system.

As used herein, the term “supply chain insurance” refers to a novel contract schema that adopts the general concepts underlying conventional insurance, which is highly prevalent as a private market solution to risk of loss allocation, and applies these concepts to the field of supply chains to provide, for example, crisis preparedness for major supply chain disruption events. Conventional insurance operates by spreading risk of loss over multiple individuals and/or entities that are willing to pay a premium in exchange for a guarantee of a relatively larger payout, typically in the form of a monetary lump sum or a series of monetary payments, in the event that loss actually occurs (e.g., in the form of or damage to property, an illness, death, etc.). The guarantor or insurer is generally willing to provide the guarantee as long as aggregate payments received across all premiums exceed payout costs, with sufficient margin for the insurer, or the risk that any loss actually occurs to trigger a claim to payout is otherwise low enough to justify taking on the guarantee. Under a supply chain insurance agreement, an entity within a supply chain (e.g., a supplier, such as a manufacturer) may act as an insurer and guarantees that the insured entity (e.g., a buyer) may purchase a volume of product, optionally with a minimum and maximum volume commitment, at an agreed-upon price production. In exchange, the insurer receives one or more premium payments paid out in lump sum or over the life term of the option. For example, a buyer of crisis products (e.g., a hospital that buys ventilators) may pay a monthly premium to a manufacturer (e.g., a producer of ventilators) in exchange for a promise the buyer may purchase the product at a later date. The buyer may then execute on the agreement to purchase the product at the underlying price previously agreed to.

Under supply chain contracts that are based on the supply chain insurance schema, or “supply chain insurance contracts”, the later date at which the buyer purchases the product may not be specified by the agreement. Rather, the buyer may have a bargained-for right under the agreement to exercise the agreement at any time either in perpetuity or over an agreed upon time period. In some embodiments, supply chain insurance contracts are structured as option contracts. Option contracts include, by definition, an option that may be exercised by an entity to the contract. For example, a buyer may have an option to purchase a quantity of a certain product and have it delivered within a certain time frame. The option contract may specify a time period within which the option must be exercised, or the option may exist in perpetuity or until the option-holding entity expressly abandons the right to exercise the option. The option contract also specifies obligations of the other entities to the contract that must be performed when the option is exercised. For example, in the case that the option specifies obligations of a supplier, the option may specify a minimum and/or maximum quantity of the product that the supplier agrees to supply, specification and/or supply format of the product (e.g., a pharmaceutical drug to be supplied as injection or as pills), a time frame within which the product must be supplied after exercising the option, and/or a location or locations to which the product must be delivered or provided. The option contract may further specify an amount that must be paid, either as a lump sum payment or as a series of payments, by the option-holding entity to other entities to the contract in order for the option-holding entity to retain the right to the option. Other terms may also be specified by the option contract.

Implementing a supply chain insurance marketplace requires economically viable pricing of the option contracts. The premium paid by an insured entity (e.g., the buyer) to retain a right to exercise the contract (i.e., purchase a quantity of product at the underlying price) must be agreeable to all supply chain entities involved in the option contract. The premium represents an economic cost to the insured entity, which must be lower than the costs associated with, for example, inventory shortages over the life of the option (e.g., during an unforeseen crisis period) for the contract to be economically viable to the buyer. At the same time, the premium must cover the economic costs associated with fulfilling obligations of the contract with sufficient margins to incentivize entities to enter into the agreement. There may be myriad considerations involved in pricing an option contract for the purposes of supply chain insurance that are atypical for standard supply chain agreements that the entities otherwise enter into. For example, the quantity specified in the agreement may significantly exceed typical production volumes of a prospective supplier, who may need to invest in manufacturing flexibility or other surge capacity solutions in order to fulfill an obligation if the supply chain insurance agreement were to be exercised. In addition, the option contract may specify lead times that are relatively quick compared to day-to-day operations. Further, the product covered by the agreement may exacerbate concerns related to a supplier's ability to fulfill volume obligations if the product, or raw materials used to produce the product, have a short lifetime/expiration cycle and cannot reasonably be stored in bulk to prepare for a case in which an option may be exercised. In some instances, an entity, such as a buyer, for example, may determine that the benefits of the option are not worth the costs, if the price of the agreement significantly increases economic costs of crisis preparedness relative to other options, such as stockpiling.

In addition to gross economic cost, additional factors must be considered to ensure the commercial viability of option contracts in a supply chain insurance marketplace. For example, risk plays a significant factor when determining whether to enter into a supply chain insurance agreement. A buyer must be assured of an adequate likelihood that the obligations would be fulfilled if the option were to be exercised. Otherwise, a buyer may determine that the value of the agreement is not worth the cost due to a risk that one or more entities will fail to fulfill their obligations. Suppliers, meanwhile, have an interest in discerning a likelihood that an option will be executed and, similarly, factors that are indicative of an option being executed. Risk may be mitigated by provisions other than the price of the agreement, such as by damage provisions (e.g., compensatory, nominal, or punitive) associated with a failure to fulfill obligations covered by a supply chain insurance agreement must be agreeable to all entities. Including these provisions in the contract may influence the premium that is paid for the option. Additionally, the term life of an option must provide sufficient economic incentive to buyers of supply chain insurance, but suppliers may not wish to enter into agreements that would give the buyer the right to exercise an option in perpetuity. Other factors may exist as well.

Because supply chain insurance is a new concept, the market for supply chain insurance contracts has not been established. As a result, there may be little market intelligence that is shared between supply chain entities to facilitate contractual terms that are agreeable to all parties to the option contract. While conventional supply chain platforms have been built to facilitate futures contracts, e.g., option contracts, between supply chain entities, the solutions provided by these platforms lack the ability to overcome complexities that are presented in implementing option contracts in a supply chain insurance market. For example, the system architecture of known supply chain platforms does not enable known systems to determine various factors that are particularly relevant in the supply chain insurance market, such as, for example, a volume demand of option contracts in the marketplace, a likelihood that any one option contract will be executed, and/or a risk that option contracts relating to a similar type of product will be contemporaneously executed, among other factors. In this regard, conventional supply chain platforms also lack the ability to accurately and dynamically generate agreeable terms for option contracts in the supply chain insurance market. This and other technical problems are solved by the present disclosure which herein describes a system architecture in which option contracts may be generated by pulling together supply chain data sets, extracting data relevant to considerations for implementing a supply chain insurance marketplace, applying machine learning algorithms to capture potentially non-linear connections in the data sets that are typically non-intuitive or not derivable by human analysis, and applying these connections to make predictions about the future evolution of such markets and generate agreeable terms for supply chain insurance contracts.

Accordingly, the systems and methods disclosed herein implement a machine learning (ML) engine that is built and/or trained to predict supply chain insurance markets and generate terms that are agreeable to supply chain entities wishing to participate in supply chain insurance. The ML engine may generate such terms by applying a plurality of finely tuned and perpetually tunable machine learning algorithms or models to make predictions or decisions relying on patterns or inferences drawn from data collected from myriad sources hosted by and/or in electronic communication with the SCI system. In the exemplary embodiment, the ML engine is executed by the SCI system to provide supply chain insurance market intelligence to supply chain entities for option contracts and other interactions in the supply chain insurance market, and predicts potential markets for supply chain insurance and generates agreeable contract terms while eliminating the research time and deep knowledge otherwise required for the entities to arrive at such terms. In some embodiments, the SCI system may act as a type of broker for facilitating supply chain insurance contracts between supply chain entities, allowing the entities to execute upon a single or multiple generated supply chain agreements. Advantageously, the SCI system may use these subsequent interactions to continuously or periodically train, update and/or refine the ML engine.

In the exemplary embodiment, the ML engine may operate by ingesting a volume of data from one or more data sets. For example, the ML engine may ingest a set of historical supply chain transaction records (e.g., hundreds, thousands, tens of thousands, hundreds of thousands, etc., of transaction records) stored in a database hosted by and/or in communication with the SCI system. Each transaction record may include information such as, for example, a product and quantity of product that was transacted, supply chain entities that executed the transaction, a transaction amount, transaction date, and transaction location, and other information. The ML engine may also ingest other data related to a supply chain. For example, supply chain data may include current and/or historical costs associated with supply chain activities that take place in procurement of a particular product or a group of similar products, such as raw material costs, inventory costs, production costs, transportations costs, and the like. Supply chain data may also include parameters or metrics indicative of current and/or historical supply chain trends, such as, for example, fluctuations in the demand and supply of products, inventory shortages, stock levels, and the like. The supply chain data may also include data regarding supply chain disruption events and the financial impact of these events. Additionally or alternatively, the SCI system may parse transaction records and supply chain data to infer supply chain disruption events, for example based on transaction and inventory trends, and the financial impact of these events, based for example on fluctuations in transaction costs before and after an inferred supply chain disruption event.

The data (e.g., transaction records and/or supply chain data) may be retrieved from existing supply chain databases. For example, the SCI system may include a third-party software integration component that integrates and/or interfaces with traditional supply chain software systems including, for example, enterprise resource planning (ERP) systems and customer relationship management (CRM) systems. The software integration component implements one or more Application Programming Interfaces (APIs) to query and parse data from the external supply chain software, and may establish connection between data repositories of the external software and the SCI system. In this way, the SCI system may seamlessly retrieve relevant data from various applications and their associated databases.

The data may be used initially to train the ML engine to identify products within a supply chain that could be transacted using supply chain insurance contracts. In this way, the ML engine may identify potential markets for supply chain insurance. The ML engine may identify the potential markets by implementing a market module that classifies products for supply chain insurance contracts. The market module performs this classification by analyzing activity trends over a specified timeframe, detecting an anomaly in a demand of a product, associating at least one negative event with the anomaly, and determining, based on inferences drawn from supply chain data, whether the at least one negative event could have been avoided. If the market module determines that the negative event could not have been avoided, the market module may classify the product as suitable for a supply chain insurance model.

Once the market module determines that a product may present a market for supply chain insurance contracts, the ML engine may also implement various modules to determine agreeable terms of the contracts. It should be appreciated that any module implemented by the ML engine may be in communication with and learn from determinations made by any other module. Further, each module may implement machine learning algorithms or models that may be trained using similar or disparate training datasets that are accumulated from data available to the SCI system.

In the exemplary embodiment, the ML engine may implement a pricing module that estimates premiums of an option contract that would be agreeable to supply chain entities. The pricing module may be implemented based on determinations made by other modules executed by the ML engine. Additionally, the ML engine may implement a volume module that determines agreeable product volumes (e.g., minimum and maximum volumes) covered by a supply chain insurance contract, and a risk module that determines a likelihood that a supply chain insurance contract would be executed.

In some embodiments, the SCI system operates as a pure market intelligence tool, executing functions of the ML engine that determine the viability of a supply chain insurance contract and generates terms based on the underlying training dataset that are predictably agreeable to supply chain entities. The SCI system may provide a user platform to supply chain entities. The platform may be accessible to the supply chain entities via an application executing on a computing device associated with the entity. The SCI system may present the outputs of the ML engine as market intelligence information to supply chain entities using the platform for example, by displaying information related to determinations made by the market, volume, and pricing modules implemented by the ML engine. The platform may enable supply chain entities using the platform to look up information associated with supply chain insurance contracts, and the entities may then use the information to facilitate negotiations for supply chain insurance contracts outside of the platform.

In some embodiments, supply chain entities may use the user-interactive platform to interact with each other, for example, by requesting, entering into, executing, and/or trading supply chain contracts. In these embodiments, the SCI system may release supply chain insurance contracts to the market by presenting these contracts on the platform and enabling supply chain entities to accept (e.g., enter into) the contract. In this way, the SCI system may serve as a broker between supply chain entities, generating terms to the supply chain insurance contracts and otherwise facilitate negotiations between the buyers and suppliers. Advantageously, the SCI system may store data related to user interactions on the platform (e.g., executed supply chain insurance contracts) and uses this data to update the training dataset to further refine and/or retrain the modules implemented by the ML engine.

Additionally, in embodiments where the SCI system provides the user-interactive platform to release supply chain insurance contracts to supply chain entities, the ML engine may implement additional modules to facilitate robust understanding of the supply chain insurance market and otherwise provide a superior user experience. For example, the ML engine may implement a demand module that predicts a volume of demand for supply chain insurance contracts that cover a particular product or a group of similar products. The ML engine may also implement the risk module to determine a likelihood that the supply chain insurance contracts covering a product or a group of similar products may be executed contemporaneously. The number of supply chain insurance contracts released to supply chain entities may be consequence of the volume of demand and the risk of contemporaneous execution of the contracts. The ML engine may also implement a rating module that predicts a failure rate or a likelihood that a supply chain entity would fail to fulfill the obligations covered by the supply chain insurance contract. The ML engine may also implement a pooling module that enables pooling of similar supply chain entities (e.g., a group of similar buyers or a group of similar suppliers) into a single supply chain insurance contract.

At least one technical problem to be solved by the systems and methods provided herein includes: (i) inability of known system architectures to derive accurate predictions about the future evolution of supply chain insurance markets and apply those predictions to determine agreeable terms to a supply chain insurance contract, (ii) lack of a user portal for supply chain entities that presents complex, machine-derived market intelligence in a fashion that enables user comprehension and transparency and provides an alternative solution to crisis preparedness in a supply chain, and/or (iii) inability to present effective data sets to train, retrain, and/or refine machine learning models to identify variables or factors in supply chain data that are relevant to predicting market behavior and generating agreeable terms to a supply chain insurance contract.

The technical effect of the systems and processes described herein may be achieved by performing at least one of the following steps: (i) parsing supply chain data to infer transaction and supply chain data trends that indicate a potential market for supply chain insurance, (ii) applying a machine learning engine to determine that a product is suitable for supply chain insurance, (iii) implementing robust, finely tuned, and perpetually tunable machine learning modules to generate terms of a supply chain insurance contract, (iv) training the machine learning engine using data for all products across multiple supply chains to reveal subtle connections among product markets that may render a first product suitable for supply chain insurance, when such connections may not have been revealed by direct review of supply chain activities related to the first product, and/or (v) refining and/or retraining the modules implemented by the machine learning engine based specific data sets, including data derived from user interactions on a user interactive supply chain insurance platform.

A technical effect or improvement provided by the systems and processes described herein include at least one of: (i) generating accurate predictions about the future evolution of supply chain insurance markets and applying those predictions to identify an initial market for supply chain insurance contracts, (ii) generating agreeable terms to a supply chain insurance contract, (iii) presenting a user portal for supply chain entities that presents complex, machine-derived market intelligence in a fashion that enables user comprehension of supply chain insurance markets, and (iv) facilitating increasing crisis preparedness across one or multiple supply chains. No known systems offer the functionality necessary to overcome the complexities required to implement supply chain insurance. Using the systems and methods described herein to identify potential supply chain entities that may enter into supply chain insurance contract and generate amenable terms for these contracts, a novel contract schema may be implemented.

The following detailed description illustrates embodiments of the disclosure by way of example and not by way of limitation. It is contemplated that the disclosure has general application to processing financial transaction data by a third party in industrial, commercial, and residential applications.

As used herein, an element or step recited in the singular and proceeded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

As the description proceeds, general reference may be made to “entities” or “supply chain entities” which include, for example, supplier entities, buyer entities, logistics services entities, and other third-party entities. Moreover, while the terms “entities” or “supply chain entities” may be generally described herein to interact, via client devices, with one another through the SCI system, it should be understood that interaction of an entity via a client device may be performed by an individual user that is associated with or is a representative of the entity, such as an employee of the entity.

A “supplier entity” or “supplier” may be generally understood to refer to an entity that produces a product, or produces a material used in the downstream production of a product, and may include, for example, manufacturers across various industries such as, for example, medical supplies, medical equipment, pharmaceuticals, personal protective equipment (or “PPE”), and/or consumer products.

A “buyer entity” or “buyer” may be generally understood to refer to an entity that procures a product for public or private consumption. A buyer entity may be an end user of a product or may be an entity that procures a product to make the product more readily available for public or private consumption. Buyer entities may include private individuals, entities within the private sector, or entities within the public sector (e.g., a government entity).

A “logistics services entity” may be generally understood to refer to any entity that manages, stores, and/or transports materials or products between multiple supplier entities, between a supplier entity and a buyer entity, and/or between a supplier entity and a buyer entity. For example, a logistics services entity may provide warehousing services for a product after it is manufactured by a supplier entity and/or may provide delivery services of the product to a buyer entity. In some examples, a logistics services entity may also be a supplier entity or a buyer entity.

A “third-party entity” or “third party” may be generally understood to refer to any other entity that provides services or products related to a supply chain. For example, a third-party entity may be a financial institution. For example, a third-party entity may include a third-party insurance provider that offers supply chain disruption insurance that may be purchased by a supplier entity, a buyer entity, and/or a logistics services entity to recover an economic loss associated with a supply chain disruption event

As used herein, a “supply chain insurance event” refers to an event that may trigger a buyer to execute on an option underlying a supply chain insurance contract.

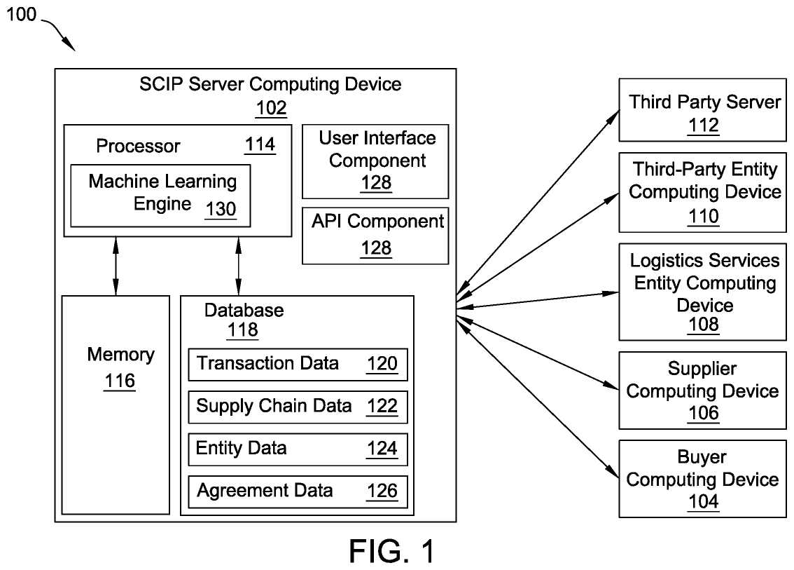

FIG. 1 is a schematic diagram illustrating an exemplary supply chain insurance (“SCI”) computing system 100 for managing supply chain agreements. In the exemplary embodiment, SCI system 100 includes an SCI server computing device 102 that is in communication with one or more of a buyer computing device 104, a supplier computing device 106, a logistics services entity computing device 108, a third-party entity computing device 110, and/or a third party server 112. In some embodiments, SCI server 102 is in communication with buyer computing device 104, a supplier computing device 106, a logistics services entity computing device 108, a third-party entity computing device 110, and/or a third party server 112 over a single network or a combination of multiple networks. For example, the network may include the Internet and/or one or more intranets, landline networks, wireless networks, and/or other appropriate types of communication networks. Additionally or alternatively, the network may comprise a wireless telecommunications network (e.g., cellular phone network) adapted to communicate with other communication networks, such as the Internet. In some embodiments, SCI system 100 may include multiple SCI servers 102, buyer computing devices 104, supplier computing devices 106, logistics services entity computing devices 108, third-party entity computing devices 110, and/or third party servers 112. SCI server 102 may include a processor 114 in communication with at least one memory 116 and at least one database 118.

The SCI server 102 stores information or data generally associated with supply chain activities on database 118. The information may be accessed by the computing devices 104-110 through SCI server 102. In one embodiment, database 118 is local to or stored on SCI server 102. In other embodiments, database 118 may be external to SCI server 102 and stored across one or more external locations. For example, database may be stored across one or more computing devices 104-110 and/or third party server 112.

Buyer computing device 104, supplier computing device 106, logistics services entity computing device 108, and/or third-party entity computing device 110 may be computers that include a client application, such as a web browser or a dedicated software application, which enables computing devices 104-110 to access remote computer devices, such as SCI server 102, over a network. Computing devices 104-110 may be any device or combination of hardware and/or software capable of wired and/or wireless communication over a network. Examples of computing devices 104-110 include, but are not limited to including, a desktop computer, a laptop computer, a personal digital assistant (PDA), a cellular phone, a smartphone, a tablet, a smart home device, a phablet, wearable electronics such as a smart watch, or other web-based connectable equipment or mobile devices. While the above-described non-limiting examples apply to computing devices 104-110, in many cases, each computing device 104-110 may be different from any other computing device 104-110 included in system 100. In other cases, two or more computing devices 104-110 may be the same computing device. For example, an entity associated with the device may be both a buyer and a supplier.

Third party server 112 may be any third party server that SCI server 102 is in communication with and that enables additional functionality of SCI server 102. For example, third party server 112 may be servers associated with third parties including, for example, other software-based supply chain platform servers. Non-limiting examples of third party servers 112 include enterprise resource planning (ERP) systems and customer relationship management (CRM) systems. Because SCI server 102 is in communication with third party server 112, the entities interacting with SCI server 102 may directly access third party servers 112, for example, through a supply chain insurance application that is executed on a client device associated with the respective supply chain entity. In some embodiments, SCI server 102 may enable access to third party applications that are hosted by third party servers 112 and executed on a client device via the supply chain insurance application using an API, for example. The SCI server 102 may also access third party servers 112, with or without input from entities interacting on the platform, and retrieve data from third party servers 112 that enables additional functionality of SCI server 102, as described in more detail below.

In some embodiments, the SCI server 102 retrieves and accumulates data from third party servers 112. For example, the SCI system may include a third-party software integration component 132 that integrates and/or interfaces with traditional supply chain software systems including, for example, ERP systems and CRM systems. The software integration component 132 implements one or more APIs to query and parse data from the external supply chain software, and may establish connection between data repositories of the external software and the SCI system.

The SCI server 102 may retrieve and accumulate, from third party servers 112, historical supply chain transaction records (e.g., hundreds, thousands, tens of thousands, hundreds of thousands, etc., of transaction records). Each transaction record may include information such as, for example, a product and quantity of product that was transacted, supply chain entities that executed the transaction, a transaction amount, transaction date, and transaction location, and other information. The SCI server 102 may also retrieve, from third party servers 112, any other data that is related to a supply chain. Supply chain data may include current and/or historical costs associated with supply chain activities that take place in procurement of a particular product or a group of similar products, such as raw material costs, inventory costs, production costs, transportations costs, and the like. Supply chain data may also include parameters or metrics indicative of current and/or historical supply chain trends, such as, for example, fluctuations in the demand and supply of products, inventory shortages, stock levels, and the like. The supply chain data may also include data regarding supply chain disruption events and the financial impact of these events. Additionally or alternatively, the SCI server 102 may parse transaction records and supply chain data to infer supply chain disruption events, for example based on transaction and inventory trends, and to infer the financial impact of these events, based for example on fluctuations in transaction costs before and after an inferred supply chain disruption event.

The SCI server 102 may also receive data from supply chain entities via computing devices 102-110. The data may be specific to the supply chain entity associated with the computing device. Supply chain entity data may include a role of the supply chain entity (e.g., a supplier or a buyer), the types of products procured by and/or services provided by the entity, a business location, a minimum and/or maximum volume demand or capacity, inventory levels, and other data.

The SCI server 102 may also receive, and store in database 118, data associated with existing supply chain agreements between, for example, buyers and suppliers that interact through the SCI server 102. The agreement data may be received from computing devices associated with parties to a contract, for example, from a buyer computing device 104 or a supplier computing device 106. The agreement data may include the terms and/or obligations that are covered by existing supply chain agreements, such as a type of product, maximum and/or minimum quantities of the product, and delivery, pricing, timing and other terms commonly specified by the agreement. The supply chain agreements are not necessarily structured as option contracts, and may include any known contract executed by supply chain entities. Non-limiting examples of supply chain agreements include fixed price contracts (e.g., firm fixed-price contracts, fixed-price incentive contracts, and fixed-price with economic price adjustment contracts), cost-plus contracts or cost reimbursement contracts (e.g., cost plus fixed fee contracts, cost plus incentive fee contracts, cost plus award fee contracts, cost plus percentage of cost contracts), purchase orders, time and materials contracts, buy-back contracts, and revenue-sharing contracts.

In some embodiments, the SCI server 102 may assign labels or classifiers to data received from computing devices 104-110 and third party servers 112. For example, as illustrated in FIG. 1, data stored in database 118 may be assigned labels representing, for example, a transaction record data 120, supply chain data 122, supply chain entity data 124, and supply chain agreement data 126. The labels may facilitate efficient analysis by the SCI server 102 (e.g., when executing a machine learning engine 130). It should be appreciated that data stored in database 118 is not limited to any particular data structure, architecture, and/or indexing scheme. The data stored in database 118 may be organized into several data fields. The SCI server 102 may organize, analyze, and process the data stored in database 118 in a manner that facilitates efficient identification of data for subsequent analysis (e.g., when executing machine learning engine 130). This may be performed by executing, e.g., via processor 114, a computer program stored in memory 116 of SCI server 102.

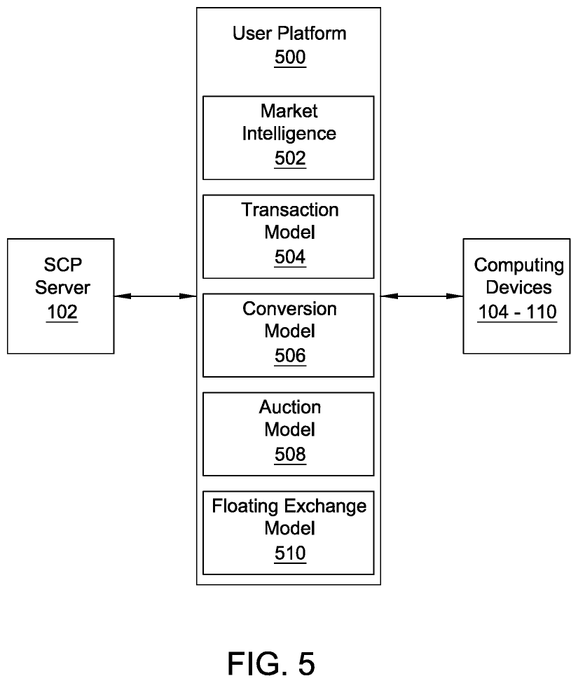

The SCI server 102 also includes a user interface component 128 configured to facilitate display of a user interface within a software application executing on a user computing device (e.g., computing devices 104-110). User interface component 128 may be executed by processor 114 of SCI server 112. In some embodiments, user interface component 128 includes an application programming interface (API) such that a plurality of computing devices 104-110 may communicate with SCI server 102. User interface component 128 additionally prepares a user platform (e.g., platform 500 shown in FIG. 5) that displays market intelligence information based on outputs generated by modules implemented by machine learning engine 130. User interface component 128 transmits a signal to one or more computing devices 104-110, the signal including instructions to display the user platform to the user interface within the application executing on a user computing device. A supply chain entity associated with one of the computing devices 104-110 may thereby track or monitor outputs generated by the machine learning engine 130. The user interface component 128 may also be configured to present supply chain insurance contracts that include terms generated by the machine learning engine 130 to computing devices 104-110, and enable other interactions on the platform.

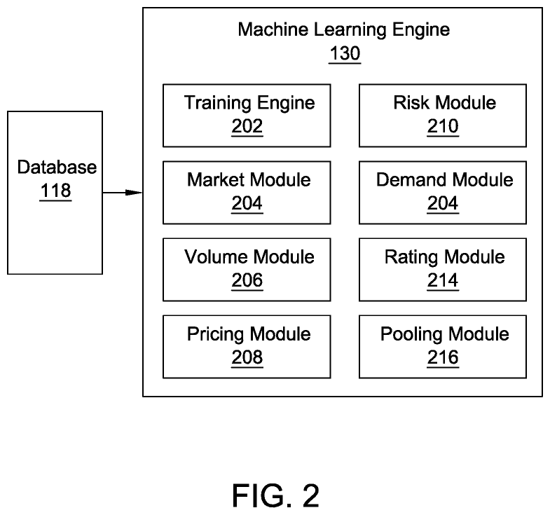

With additional reference to FIG. 2, in the exemplary embodiment, the SCI server 102 includes machine learning engine 130 and executes the machine learning engine 130 to facilitate providing market intelligence information to supply chain entities and, in some embodiments, to function as a type of supply chain insurance broker system. The machine learning engine 130 is executed to evaluate the data in database 118, make predictions or decisions relying on patterns and inferences drawn from the underlying data, and generate outputs that facilitate market intelligence and transparency in a supply chain insurance market and, in some embodiments, facilitate generating supply chain insurance contracts that may be released to supply chain entities interacting with the SCI server 102, e.g., via a user-interactive platform 500.

The machine learning engine 130 implements a plurality of machine learning algorithms or models via various modules configured on the engine. In some embodiments, multiple machine learning engines 130 may be provided, where each engine implements one or more of the modules. Each module may comprise a plurality of machine learning algorithms or models that work together to identify or classify features of data in the database that can be used to enable machine learning engine 130 to generate appropriate outputs. Further, each module may utilize outputs generated by another other module as inputs to further refine and/or update the algorithms or models implemented by the module. Therefore, it should be appreciated that any module implemented by the machine learning engine 130 may be in communication with and learn from determinations made by any other module. Further, each module may implement machine learning algorithms or models that may be trained using similar or disparate training datasets that are accumulated from data available to the SCI server 102.

Each module implemented by the machine learning engine 130 may be trained using a training engine 202. The training engine 202 parses data in database 118 and accumulates one or more training datasets that is used to train the modules implemented by the machine learning engine 130. Over time, the training engine 202 may continuously refine and update the training datasets based, for example, on outputs generated by any of the other modules implemented by the machine learning engine 130. Additionally, in embodiments where the SCI server 102 implements a user interactive platform 500 (shown in FIG. 5), the training engine 202 may accumulate data based on interactions of supply chain entities using the platform 500, as described in further detail herein.

The training engine 202 may train one or more machine learning algorithms using supervised or unsupervised machine learning. In supervised machine learning, the training engine 202 may parse data stored in database 118 and provide machine learning engine 130 with example inputs and their associated outputs. The machine learning engine 130 may seek to discover a general rule that maps inputs to outputs, so that when subsequent novel inputs are provided the processing element may, based upon the discovered rule, accurately predict the correct output. In unsupervised machine learning, the machine learning engine 130 may be required to find its own structure in unlabeled example inputs provided by training engine 202.

The training engine 202 may also train one or more machine learning algorithms by parsing the aggregated data and extracting sample data sets and inputting the extracted data into the machine learning engine 130. Models may be created based upon example inputs in order to make valid and reliable predictions for novel inputs. The machine learning engine 130 may utilize deep learning algorithms that may be primarily focused on pattern recognition, and one or more machine learning algorithms may be trained after the training engine 202 inputs multiple examples into machine learning engine 130 and the machine learning engine 130 processes the multiple examples. The machine learning engine 130 may also utilize natural language processing, semantic analysis, automatic reasoning, and/or other types of machine learning or artificial intelligence.

In the exemplary embodiment, once the machine learning engine 130 is trained using data parsed and input by training engine 202, the SCI server 102 may execute machine learning engine 130 to classify products within a supply chain that could be transacted using supply chain insurance contracts and generate and/or predict terms for supply chain insurance contracts for these products.

The machine learning engine 130 may implement a market module 204 that is trained to classify products for supply chain insurance contracts. Advantageously, the market module 204 may be trained using data for a plurality of products across one or multiple supply chains. This may reveal subtle connections among product markets that indicate that a particular product is suitable for supply chain insurance. Such connections may be undetectable by direct review of the supply chain activities for the particular product.

The market module 204 may classify suitable products for supply chain insurance by analyzing activity trends over a specified timeframe, detecting an anomaly in a demand of a product, associating at least one negative event with the anomaly, and determining, based on inferences drawn from underlying data stored in database 118 (e.g., supply chain data 122 and/or entity data 124), that the product could be transacted under a supply chain insurance model.

The market module 204 may analyze activity trends by observing the transaction behavior between a supply and a buyer, or multiple suppliers and multiple buyers. Suitably, the market module 204 observes transaction behavior classified by product or a group of similar products. For example, the market module 204 may analyze transaction trends for ventilators purchased by a buyer (e.g., a hospital) over a specified timeframe (e.g., several years). The market module 204 may then detect anomalies in the purchasing behavior of hospitals for ventilators year over year. For example, in years one and two, a hospital may have purchased a first amount of ventilators (e.g., 10 ventilators). In year three, the hospital may have purchased a second amount of ventilators (e.g., 100 ventilators in each year). Finally, in year four, the hospital may have again purchased the first amount of ventilators. The market module 204 may thereby detect that an anomaly occurred for the demand of ventilators in year three based on the significant increase in the amount of ventilators transacted.

Once the market module 204 detects anomalies in the demand for a particular product, the market module 204 may analyze additional supply chain data to determine whether a negative event occurred within the same time period as the anomalous transaction behavior. Negative events may include, for example, inventory shortages, increased costs of a product, transportation and/or delivery delays, or any other event that is undesirable in the procurement of a product. The market module 204 may be trained to associate the negative events by establishing a likely relationship between the negative event and the anomalous transaction behavior based on inferences drawn from the underlying data. The negative event may be directly related to the particular product (e.g., an inventory shortage of the product) or may be indirectly related (e.g., may be directly associated with another product). In this way, the market module 204 may identify negative events in product markets outside of the direct supply chain for a particular product that can be attributed to a particular product. Such connections may remain unrevealed by direct review of supply chain activities for a particular product.

The market module 204 may then determine that the negative event could have been avoided under the existing supply chain structure. The market module 204 may be initially trained to make this determination based on various factors and variables that the market module 204 can extract or infer from the underlying data. The factors and variables may generally be associated with the production and logistical requirements for procuring the product. This may include raw material lead times, production requirements, transportation requirements, and storage requirements. Essentially, the market module 204 is trained to determine whether existing supply could feasibly ramp up to meet demand during anomalous transaction behavior so as to prevent the negative event from occurring. If so, the market module 204 may determine that the product is not suitable for supply chain insurance. In addition, the market module 204 may also determine whether supply chain insurance is a suitable alternative to, for example, stockpiling of the product. This may be determined based on analyzing the product lifetime and storage costs, among other considerations that can be extracted or inferred from the underlying data.

In this regard, the market module 204 may be configured to classify products based on their suitability for supply chain insurance. By training the market module 204 using data associated with a plurality of products across one or multiple supply chains, the market module 204 may be configured to identify negative events that are either directly or indirectly attributable to anomalous transaction behavior of a particular product. The market module 204 may then determine that negative events associated with anomalous transaction behavior of certain products may be avoidable in future crisis periods. For example, if the market module 204 determines that a supply chain can quickly catch up with a demand surge, or that negative events may be avoided by other measures (e.g., stockpiling), the market module 204 may classify the product as a non-supply chain insurance product. For other products, however, such as those with long lead times, and/or those having an immediate need during a crisis period, the market module 204 may classify these products as suitable for supply chain insurance.

In some embodiments, the market module 204 may also be configured to classify particular entities (e.g., particular buyers and particular suppliers) that would be amenable to supply chain insurance. The entities classified by market module 204 may represent a subset of all entities that transact a product determined by the market module 204 to be suitable for supply chain insurance. This subset of entities may include buyers that are classified based on their particular demand and the economic costs associated with inventory shortages for the specific buyer. For example, in some instances, although multiple buyers may exist in a supply chain for a particular product, the market module 204 may determine that only a subset of buyers would experience inventory shortages or other negative events during a supply chain insurance event. Additionally, the market module 204 may determine that the economic costs associated with some buyers would not incentivize the buyers to purchase a supply chain insurance contract. This may be based on a supply chain insurance contract price term generated by a pricing module 208. Similarly, the subset of entities classified by market module 204 may include suppliers that are classified based on their production capabilities and current product volumes provided. This may be based on a supply chain insurance contract volume term generated by a volume module 208. In some cases, for example, suppliers may service such low quantities that the market module 204 classifies these suppliers as outside an appropriate class of suppliers that are suitable for servicing supply chain insurance contracts.

Once the market module 204 classifies a product as suitable for supply chain insurance, and optionally a class of entities associated with the procurement of the product, the machine learning engine 130 may implement various modules to enable the machine learning engine 130 predict or determine agreeable terms of the contracts. Each of the modules may be implemented to determine one or more terms, or one or more variables or factors useful in determining one or more terms of a supply chain insurance contract. For example, the machine learning engine 130 may implement the volume module 206, the pricing module 208, and a risk module 210.

The volume module 206 may be implemented to generate a volume term that would be included in a supply chain insurance contract for a product classified by market module 204 as suitable for supply chain insurance. The volume term may be a single term or may be a range of volumes (e.g., minimum and maximum volumes). The volume module 206 may generate the volume term by analyzing the transaction trends of the particular product, inventory trends, and other data that is indicative of an amount of product that may be desired during a supply chain insurance event. The volume module 206 may also analyze existing supply chain contracts covering a particular product and make determinations about supply chain insurance volumes based on volume terms included in the existing contracts. The volume module 206 may also analyze supply chain data associated with logistics of a product (e.g., transportation) and determine appropriate minimum and/or maximum quantities of a product during a supply chain insurance event where logistics can be provided.

Advantageously, the volume term generated by the volume module 206 need not be restricted to product volumes that can feasibly be serviced under the existing supply chain structure. For example, the volume term may exceed production capacity, inventory, or other logistical limits. In this regard, the volume term may provide market intelligence for changes that would need to be implemented in order for a supply chain insurance contract to be fulfilled. For example, the volume term can be used by suppliers to determine what investments need to be made to existing production facilities to service a supply chain insurance contract upon execution by the buyer. The pricing module 208 may thereby take the volume term generated by the volume module 206 into account when determining appropriate pricing for the supply chain insurance contract, described in further detail below.

The pricing module 208 may be implemented to generate a price term of the supply chain insurance contract. The price is generated by estimating both an agreeable purchase price of the product upon execution of the contract option as well as an agreeable premium that a buyer would pay for the supply chain insurance contract. The purchase price may simply be determined based on current and/or historical prices of the product. In some embodiments, the pricing module 208 may employ robust pricing models for the purchase price of the product under the contract, taking into account activity and production costs in the supply chain (e.g., production and inventory costs, raw materials estimates, transportation costs, and the like). The pricing module 208 may factor in the premium by analyzing the costs to the buyer that occur during a supply chain insurance event. For example, the pricing module 208 may look at costs associated with inventory shortages during a supply chain insurance event. The pricing module 208 may extract or infer these costs based on supply chain data, which may include data associated with lost profits and other economic costs associated with inventory shortages. Additionally or alternatively, the pricing module 208 may be trained with an economic model that models economic costs to a buyer as a result of inventory shortages.

The pricing module 208 may also factor in the premium by analyzing the costs that would be associated with a supplier in order to facilitate executing obligations specified by a supply chain insurance contract. For example, the pricing module 208 may utilize the volume terms generated by volume module 206 and compare these terms to existing supplier capabilities. The pricing module 208 may infer or predict that a supplier would have to invest in additional production capabilities to deliver a demand under the supply chain insurance contract. The pricing module 208 may extract or infer these costs based on supply chain data, which may include data associated with increasing production volumes and capabilities. Additionally or alternatively, the pricing module 208 may be trained with an economic model that models economic costs to a supplier or suppliers to ramp up supply capabilities and production volumes.

In some embodiments, the pricing module 208 may be configured to set a market rate for supply chain insurance contract price terms by comparing economic costs across a variety of buyers and suppliers of the product. The pricing module 208 may only take into account buyers and suppliers that the market module 204 classifies as suitable entities for supply chain insurance contracts. The pricing module 208 may generate the market rate based on, for example, an average economic costs of buyers and suppliers.

In some embodiments, the pricing module 208 may determine an optimal payment structure of the pricing term for the supply chain insurance contract. For example, the pricing module 208 may determine that raw materials for a product do not need to be repurchased year over year, and that the raw material cost could potentially be spread over the lifetime of the supply chain insurance contract as a perpetuity. The pricing module 208 may determine optimal payment frequency based on contract duration. For example, the supply chain insurance contract may vary from 1 month to 5 years to “good until canceled” with payment frequency variable as well.

The risk module 210 may be implemented to predict a likelihood that a supply chain insurance contract would be executed. The risk module 210 may make this prediction by analyzing transaction trends, inventory trends, disruption events, and other data that is indicative of a frequency of supply chain insurance events. The risk module 210 may also extract or infer a frequency of supply chain insurance events based on supply chain data, which may include data associated with supply chain disruption events. The risk module 210 may equate or associate supply chain disruption events with supply chain insurance events.

Referring to FIG. 5, in the exemplary embodiment, the SCI server 102 provides a user platform 500 to supply chain entities. The supply chain entities may view and interact with user platform 500 through a user interface of a client device associated with each supply chain entity (e.g., computing devices 104-110). The user platform 500 may be generated by a client application installed on a client device, and/or may be accessed via a web browser application on the client device that accesses one or more web pages hosted by the SCI server 102.

The user platform 500 includes a market intelligence feature 502 configured to display information associated with outputs generated by the machine learning engine 130. For example, the user platform 500 may display information about products that the market module 204 predicts are suitable for supply chain insurance, and buyers and suppliers that may further be classified as suitable participants in supply chain insurance. The user platform 500 may also display terms of supply chain insurance contracts that the machine learning engine 130 predicts would be agreeable to buyers and suppliers that would enter into supply chain insurance contracts. For example, the user platform 500 may display pricing terms and volume terms of the supply chain insurance contracts. In addition, the user platform 500 may display information associated with a likelihood that a supply chain insurance contract would be executed. Supply chain entities may browse the user platform 500 for particular products or other entities interacting on the platform and view supply chain insurance information associated with these products and entities. The platform 500 may thereby enable supply chain entities using the platform 500 to look up information associated with supply chain insurance contracts, and the entities may then use the information to facilitate negotiations for supply chain insurance contracts outside of the platform 500.

In some embodiments, the user platform 500 is a user-interactive platform that enables supply chain entities to interact with each other, for example, by requesting, entering into, executing, and/or trading supply chain contracts. In these embodiments, the SCI server 102 may generate executable supply chain insurance contracts using terms generated by the machine learning engine 130 and subsequently release the supply chain insurance contracts to the market. For example, the SCI server 102 may present these contracts on the platform 500 and enable supply chain entities to accept (e.g., enter into) the contract. The SCI server 102 may store data associated with accepted supply chain insurance contracts in database 118. Training engine 202 may parse this data to update the training dataset to further refine and/or retrain the modules implemented by the machine learning engine 130. Thereby, the machine learning engine 130 may continuously learn from supply chain insurance contracts that presumably included agreeable terms (indicated by the supply chain entities actually entering into contracts that included those terms) that were generated by the machine learning engine.

Referring back to FIG. 2, in embodiments where the SCI server 102 provides the user-interactive platform 500 to release supply chain insurance contracts to supply chain entities, the machine learning engine 130 may implement additional modules to facilitate robust understanding of the supply chain insurance market and otherwise provide a superior user experience. For example, the machine learning engine 130 may implement a demand module 212 that predicts a volume of demand for supply chain insurance contracts that cover a particular product or a group of similar products. The volume of demand may be predicted by analyzing the number of buyers identified and/or classified by market module 204 as suitable for supply chain insurance contracts covering a particular product or group of similar products. The volume of demand may further be predicted by analyzing the pricing term generated by pricing module 204 and/or the volume term generate by volume module 206 and comparing data associated with each of the buyers identified and/or classified by the market module 204 to predict the number of these buyers that would be amenable to these terms.

The machine learning engine 130 may also implement the risk module 210 to predict or determine a likelihood that the supply chain insurance contracts covering a product or a group of similar products may be executed contemporaneously (e.g., at the same time) or whether these contracts would be executed at different times. The risk module 210 may make this determination or prediction based on the volume of demand predicted by the demand module 212 and determining the likelihood that each of these supply chain insurance contracts would be executed by buyers that purchase these contracts. The risk module 210 may then infer the supply chain insurance event that would cause execution of these contracts. This inference may be made based on the particular product or type of products covered by the contract. In some cases, the risk module 210 may determine or predict a high likelihood that the execution pattern will be homogeneous (i.e., that all the contracts would be executed all at once) because the supply chain insurance event would be common to all buyers of the contracts. For example, for supply chain insurance contracts covering a particular pharmaceutical drug, the supply chain insurance event for each of these contract may be inferred to be a disease outbreak that would increase demand globally for the pharmaceutical drug, and therefore the risk module 210 determines or predicts that each of the buyers of the contracts would execute on the contracts. However, in other cases, the risk module 210 may determine a low likelihood that the execution pattern will be homogenous because the supply chain insurance event would not be common to all buyers of the contracts. For example, for supply chain insurance contracts covering rescue equipment or supplies for weather events (e.g., a tornado or a hurricane), supply chain insurance events are local, not global, and therefore the risk module 210 determines or predicts that only certain buyers of the contracts (e.g., buyers that are local to the weather event) would execute on the contracts.

The SCI server 102 may release a number of executable supply chain insurance contracts to the market. The number may be based on one or both of the volume of demand predicted for the contracts and the risk that each of these contracts would be executed contemporaneously. In some cases, the SCI server 102 may release fewer supply chain insurance contracts than could serve the volume of demand, because the likelihood that each of these contracts would be executed contemporaneously makes it infeasible to serve this demand. In other cases, however, demand for the supply chain insurance contracts may so outstrip supply that the SCI server 102 may log the quantity of “desired but not realized options.” In these cases, the SCI server 102 may determine that it would be economically viable for entities to prepare to serve this excess demand given the volume guarantee of options and associated economics. These considerations could also be accounted for by pricing module 208 in determining the pricing term of the supply chain insurance contracts.

The machine learning engine 130 may also implement a rating module 214 that generates ratings for entities (e.g., suppliers and buyers) interacting on the platform 500. The ratings may represent a likelihood that the entity would fulfill the obligations covered by the supply chain insurance contract. In some embodiments, data analyzed by rating module 214 to predict or determine the likelihood of fulfillment may include failure rates of entities that are stored in third party sever 112 databases. The rating module 214 may additionally or alternatively analyze historical data relating to executed contracts between supply chain entities and determining failure rates of these contracts. The rating module 214 may then compare these previous contracts and associated failures to the terms of the supply chain insurance contract and likelihood of execution and predict rates for those entities accordingly. The SCI server 102 may then present the ratings generated by the rating module 214 on platform 500. These ratings generated by rating module 214 could also be accounted for by pricing module 208 in determining the pricing term of the supply chain insurance contracts.

The machine learning engine 130 may also implement a pooling module 216 that determines or predicts groups of entities (e.g., a group of similar buyers or a group of similar suppliers) that would be amenable to entering into a single supply chain insurance contract. The pooling module 216 may receive the entities that market module 204 classifies as would be amenable to supply chain insurance. The pooling module 216 may then further classify these entities into subsets based on common features. For example, the pooling module 216 may classify these entities based on location (e.g., buyers that receive product at a similar location or suppliers that manufacture products at a similar location). The pooling module 216 may then infer that the classified entities would be amenable to pooling logistics for a cheaper supply chain insurance contract price. The pricing module 208 may be implemented to determine whether a lower pricing term would be associated with pooling the logistics between multiple entities. The SCI server 102 may then present supply chain insurance contracts with recommendations to the classified entities to pool together into the contract on platform 500.

Referring back to FIG. 5, the SCI server 102 may enable additional functionality on user platform 500 for interaction between supply chain entities with respect to supply chain insurance contracts. For example, executing on the platform 500 may be one or more functional models including a transaction model 504, a conversion model 506, an auction model 508, and a floating exchange model 510. In some embodiments, the platform 500 may include, one, several, or all of these functional models. Advantageously, the SCI system may receive and store data related to user interactions through the models executing on the platform 500. Training engine 202 may parse this data to further refine and/or retrain the modules implemented by the machine learning engine 130.

Using the transaction model 504, entities (e.g., buyers and suppliers) interact on the platform 500 to establish terms and transact with supply chain insurance contracts. The platform 500 may thereby serve as a broker, and use the modules implemented by the machine learning engine 130 to generate terms to the supply chain insurance contracts and otherwise facilitate negotiations between the buyers and suppliers. The transaction itself, terms of the contract, and existence of buyer-seller partnership could be hidden or visible. In some embodiments, a buyer may formally request a supply chain insurance contract using the transaction model 504 that has not yet been offered by suppliers or proactively purchase supply chain insurance contracts that have not otherwise been agreed to. The request may cause the machine learning engine 130 to predict agreeable terms of a supply chain insurance contract covering a product indicated by the request, and the SCI server 102 may subsequently notify relevant entities (e.g., those determined by market module 204 as amenable to supply chain insurance for the product) of the demand and the predicted contract terms. Buyers and suppliers may also be enabled to browse the platform 500 for supply chain insurance contracts and request quotes and see offers for complementary products. Other entities interacting on the platform may be notified of the requests submitted onto the platform 500, and may receive suggestions to place additional supply chain insurance contracts onto the platform 500. In some embodiments, the transaction model 504 may be implemented together with the auction model 508, where entities may place bids on requests, described in more detail below. Entities may also be able to purchase “add-ons” (e.g., supply chain disruption insurance), and include these terms in the supply chain insurance contract. Such add-ons may be offered by third party entities interacting on the platform 500. The platform 500 may also provide notifications to entities that enter into supply chain insurance contracts, providing visibility into each step in the process. The notifications may be provided to track production, track a shipment, and the like.

As entities interact on the platform 500 via the transaction model 504, data is collected relating to supply chain insurance contracts being requested or entered into by the entities. For example, a buyer may request a supply chain insurance contract for a quantity of a product (e.g., 100 ventilators). The buyer may include in the request an amount that the buyer is willing to pay for the contract. This data is then collected and parsed by training engine 202, which includes this data in the training dataset used to train one or more of the modules implemented by the machine learning engine 130. For example, the data may be input into volume module 206 to retrain the module with the additional data indicating volume terms that a buyer would be agreeable to for supply chain insurance contracts covering the product. Similarly, the data may be input into pricing module 208 to retrain the module with the additional data indicating pricing terms that a buyer would be agreeable to for supply chain insurance contracts covering the product. Moreover, the training engine 202 may classify this data based on whether the supply chain insurance contract requested by the buyer was accepted by a supplier. If the supply chain insurance contract is accepted, the training engine 202 may flag the requested terms as agreeable to suppliers. If the supply chain insurance contract is rejected, the training engine may flag the requested terms as not agreeable to suppliers.

Using the conversion model 506, buyers and suppliers may upload existing supply chain contracts to the platform 500. Alternatively, the platform 500 may retrieve existing supply chain contracts from database 118 that were previously collected from third party servers 112 (e.g., via third party supply chain software databases). The buyers and suppliers may input desired modifications to these contracts (e.g., adding volume). The existing supply chain contracts and proposed modifications are then input into machine learning engine 130 which automatically converts all or a portion of the supply chain agreement to a supply chain insurance contract.

As entities interact on the platform 500 via the conversion model 506, data is collected relating to terms of supply chain insurance contracts based on underlying supply chain contracts. This data is then collected and parsed by training engine 202, which includes this data in the training dataset used to train one or more of the modules implemented by the machine learning engine 130. Thereby, the modules implemented by machine learning engine 130 may be able to generate agreeable terms based on terms of existing supply chain contracts. For example, the volume module 206 may be retrained and configured to identify agreeable volume terms based on existing supply chain contracts.

Using the auction model 508, buyers and suppliers could both offer and/or bid on supply chain insurance contracts. The auction model 508 generates auctions that close at a predetermined time, upon which the buyer and supplier would agree to the closing terms of the supply chain insurance contract. Auctions generated by the auction model 508 may be visible and available to all supply chain entities interacting on the platform 500. Alternatively, the auction model 508 may identify pre-qualified buyers and suppliers and may restrict visibility and/or interactions with the auction model 508 (e.g., ability to bid on a supply chain insurance contract) to the prequalified entities. Such entities may be classified using the ratings generated by ratings module 214. The auction model 508 may be implemented as a buyer model, in which suppliers list a specific volume of supply chain insurance contracts, which include timing, delivery requirements and other terms, and the buyers are enabled to bid up on price of the supply chain insurance contract. Alternatively, the auction model 508 may be implemented as a seller model, in which a buyer or multiple buyers request a specific volume of supply chain insurance contracts, which include timing, delivery requirements and other terms, and suppliers are enabled to bid down on price. Alternative variations of the auction model 508 may include “buy-it-now” or sealed bid models.

As entities interact on the platform 500 via the auction model 508, data is collected to refine intelligence of the supply chain insurance market as indicated by the bids placed over the period of the auction. This data is then collected and parsed by training engine 202, which includes this data in the training dataset used to train one or more of the modules implemented by the machine learning engine 130. Thereby, the modules implemented by machine learning engine 130 may be able to generate agreeable terms that more accurately reflect the current market for supply chain insurance contracts. For example, the pricing module 206 may be retrained and configured to identify agreeable pricing terms based on how the bidding price fluctuates over the period of the auction.

Using the floating exchange model 510, suppliers may offer a specific volume of supply chain insurance contracts with timing, delivery requirements and other terms. Buyers can purchase these contracts at a “market rate,” which may be determined by pricing module 208. The floating exchange model 510 enables the market rate to fluctuate depending on demand and other factors. For example, a buyer might purchase a supply chain insurance contract at $20 that would later be valued at $40. That buyer could sell for $40 or retain the supply chain insurance contract and be entitled to the same terms as someone who buys in at $40 (either the same or a different buyer). Under the floating exchange model 510, multiple sellers could also pool supply chain insurance contracts that cover like-for-like products. Doing so essentially creates a commodity type market for supply chain insurance contracts across a broad range of products.

As entities interact on the platform 500 via the floating exchange model 510, data is collected to refine intelligence of the supply chain insurance market as indicated by the pricing trends and contract exchange behavior over time. This data is then collected and parsed by training engine 202, which includes this data in the training dataset used to train one or more of the modules implemented by the machine learning engine 130. Thereby, the modules implemented by machine learning engine 130 may be able to generate agreeable terms that more accurately reflect the current market for supply chain insurance contracts. For example, the pricing module 206 may be retrained and configured to identify agreeable pricing terms based on how the buyers value the supply chain insurance contracts over time.

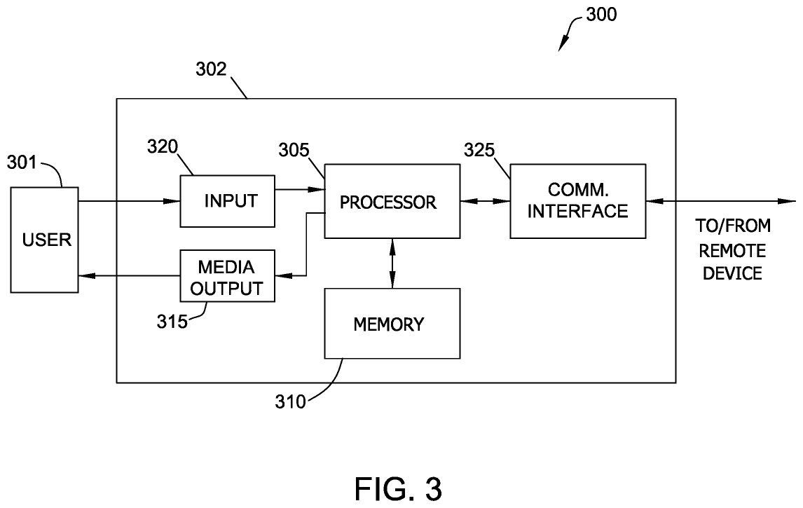

FIG. 3 illustrates an exemplary configuration of a client system 300 in accordance with one embodiment of the present disclosure. In the example embodiment, client system 300 includes at least one user computing device 302, operated by a user 301. Embodiments of user computing device 302 may be used to implement one or more of buyer computing device 104, supplier computing device 106, logistics services entity computing device 108, third-party entity computing device 110, and third party server 112 (all shown in FIG. 1). User computing device 302 includes a processor 305 for executing instructions, and a memory area 310. In some embodiments, executable instructions are stored in memory area 310. Processor 305 may, for example, include one or more processing units (e.g., in a multi-core configuration). Memory area 310 may, for example, be any device allowing information such as executable instructions to be stored and retrieved. Memory area 310 may further include one or more computer readable media.

In the exemplary embodiment, user computing device 302 further includes at least one media output component 315 for presenting information to user 301. Media output component 315 may, for example, be any component capable of converting and conveying electronic information to user 301. For example, media output component 315 may be a display component configured to display component lifecycle data in the form of reports, dashboards, communications, and the like. In some embodiments, media output component 315 includes an output adapter (not shown), such as a video adapter and/or an audio adapter, which is operatively coupled to processor 305 and operatively connectable to an output device (also not shown), such as a display device (e.g., a cathode ray tube (CRT), liquid crystal display (LCD), light emitting diode (LED) display, or “electronic ink” display) or an audio output device (e.g., a speaker or headphones).

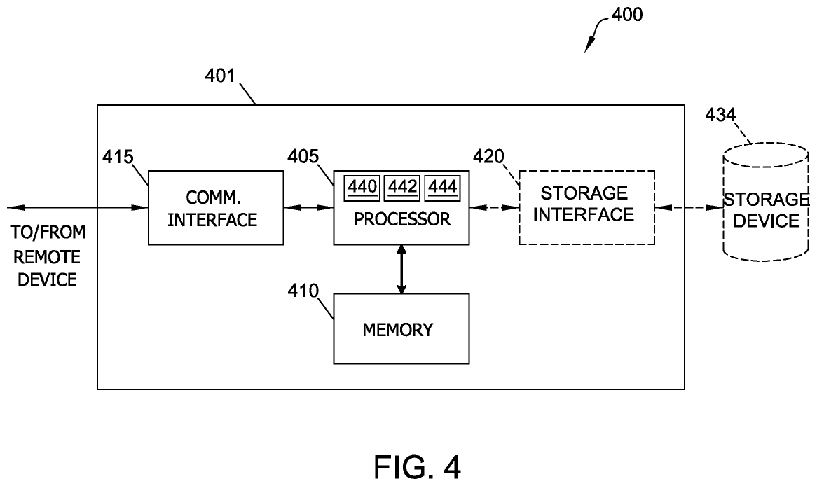

In some embodiments, media output component 315 is configured to include and present a graphical user interface (not shown), such as a web browser and/or a client application, to user 301. In some embodiments, user computing device 302 includes an input device 320 for receiving input from user 301. Input device 320 may include, for example, a keyboard, a pointing device, a mouse, a stylus, a touch sensitive panel, a touch pad, a touch screen, a gyroscope, an accelerometer, a position detector, an audio input device, a fingerprint reader/scanner, a palm print reader/scanner, a iris reader/scanner, a retina reader/scanner, a profile scanner, or the like. A single component such as a touch screen may function as both an output device of media output component 315 and input device 320. User computing device 302 may also include a communication interface 325, which is communicatively connectable to a remote device such as server system 400 (shown in FIG. 4). Communication interface 325 may include, for example, a wired or wireless network adapter or a wireless data transceiver for use with a mobile phone network (e.g., Global System for Mobile communications (GSM), 3G, 4G or Bluetooth) or other mobile data network (e.g., Worldwide Interoperability for Microwave Access (WIMAX)).

Stored in memory area 310 are, for example, computer readable instructions for providing a user interface to user 301 via media output component 315 and, optionally, receiving and processing input from input device 320. A user interface may include, among other possibilities, a web browser, and client application. Web browsers enable users, such as user 301, to display and interact with media and other information typically embedded on a web page or a website from SCI server 102 (shown in FIG. 1). A client application allows user 301 to interact with a server application from SCI server 102. For example, instructions may be stored by a cloud service, and the output of the execution of the instructions sent to the media output component 315.

Processor 305 executes computer-executable instructions for implementing aspects of the disclosure. In some embodiments, the processor 305 is transformed into a special purpose microprocessor by executing computer-executable instructions or by otherwise being programmed.

FIG. 4 illustrates an exemplary configuration of a server system 400. In the exemplary embodiment, server system 400 includes at least one server computing device 401, in electronic communication with at least one storage device 434. Server computing device 401 may be used to implement SCI server 102 (shown in FIG. 1). Server computing device 401 may also include a processor 405 for executing instructions (not shown) stored in a memory area 410. In an embodiment, processor 405 may include one or more processing units (e.g., in a multi-core configuration) for executing instructions. For example, the processor 405 may be programmed with instructions such that it may execute the processes as illustrated in FIG. 5, below. The instructions may be executed within various different operating systems on the server system 400, such as UNIX®, LINUX® (LINUX is a registered trademark of Linus Torvalds), Microsoft Windows®, etc. More specifically, the instructions may cause various data manipulations on data stored in a storage device 434 (e.g., create, read, update, and delete procedures. It should also be appreciated that upon initiation of a computer-based method, various instructions may be executed during initialization. Some operations may be required in order to perform one or more processes described herein, while other operations may be more general and/or specific to a particular programming language (e.g., C, C#, C++, Java, or other suitable programming languages, etc.).

In the exemplary embodiment, processor 405 may include one or more modules implemented by a machine learning engine (e.g., machine learning engine 130 shown in FIG. 1) for implementing the disclosed systems and methods. Processor 405 may include a market module 440 configured, for example, identifying or classifying products (and, optionally, supply chain entities) that may be suitable for supply chain insurance. Processor 405 may further include a volume module 442 configured, for example, to determine or predict agreeable volume terms of supply chain insurance contracts. Processor 405 may further include a pricing module 444 configured, for example, to determine or predict agreeable pricing terms of supply chain insurance contracts.

In the exemplary embodiment, processor 405 is operatively coupled to a communication interface 415 such that server system 400 is capable of communicating with a remote device such as a user computing (e.g., computing devices 104-110 shown in FIG. 1) or another server system 400. For example, communication interface 415 may receive requests from client system 300 (shown in FIG. 4) via the Internet, within the scope of the embodiment illustrated in FIG. 1.

In the exemplary embodiment, processor 405 is also operatively coupled to storage device 434, which may be, for example, any computer-operated hardware unit suitable for storing and/or retrieving data. In some embodiments, storage device 434 is integrated in server system 400. For example, server system 400 may include one or more hard disk drives as storage device 434. In certain embodiments, storage device 434 is similar to database 118 (shown in FIG. 1). In other embodiments, storage device 434 is external to server system 400 and may be accessed by a plurality of server systems 400. For example, storage device 434 may include multiple storage units such as hard disks or solid state disks in a redundant array of inexpensive disks (RAID) configuration. Storage device 434 may include a storage area network (SAN) and/or a network attached storage (NAS) system.

In some embodiments, processor 405 is operatively coupled to storage device 434 via a storage interface 420. Storage interface 420 may include, for example, a component capable of providing processor 405 with access to storage device 434. In some embodiments embodiment, storage interface 420 further includes one or more of an Advanced Technology Attachment (ATA) adapter, a Serial ATA (SATA) adapter, a Small Computer System Interface (SCSI) adapter, a RAID controller, a SAN adapter, a network adapter, and/or any similarly capable component providing processor 405 with access to storage device 434.

Memory area 410 may include, but is not limited to, random-access memory (RAM) such as dynamic RAM (DRAM) or static RAM (SRAM), read-only memory (ROM), erasable programmable read-only memory (EPROM), electrically erasable programmable read-only memory (EEPROM), non-volatile RAM (NVRAM), and magneto-resistive random-access memory (MRAM). The above memory types are for example only, and are thus not limiting as to the types of memory usable for storage of a computer program. In certain embodiments, memory area 410 is similar to memory 116 (shown in FIG. 1).

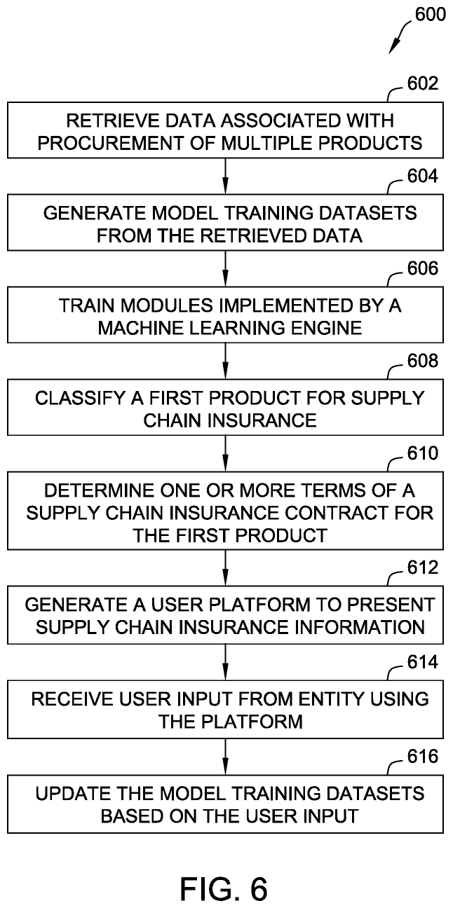

Referring to FIG. 6, an example method 600 for modeling and generating supply chain insurance contracts in accordance with an embodiment of the present disclosure is shown. The method 600 includes retrieving 602 data associated with procurement of a plurality of products. The data includes, for example, transaction records of the plurality of products between supply chain entities and supply chain agreements between entities for the plurality of products. The retrieved data may also include any other data that is relevant to modeling and generating supply chain insurance contracts, for example, data that is relevant to identifying products and supply chain entities that are suitable for supply chain insurance, and data that is relevant to determining agreeable terms of supply chain insurance contracts. In this regard, data may include any data that is available relating to supply chain activities, for example, transaction data 120, supply chain data 122, entity data 124, and agreement data 126 described above.

Using the data retrieved at 602, model training datasets are generated at 604. The model training datasets may be generated using training engine 202 (shown in FIG. 2). The training engine 202 may generate 604 the model training datasets by parsing the data retrieved at 602. Over time, the training engine 202 may continuously refine and update the training datasets based, for example, on outputs generated by any of the other modules implemented by the machine learning engine 130 and user inputs received from supply chain entities using a user platform.

In one example, a model training dataset for training a market module 204 is generated at 604. The market module training dataset may include transaction trends of the plurality of products based on the transaction records. At 606, the market module 204 is trained to classify a suitability of each of the plurality of products for supply chain insurance based on the transaction trends. In some examples, the market module 204 is trained at 606 based on transaction trends of products that have previously been identified to be suitable for supply chain insurance. The market module 204 may thereby be trained to develop a set of rules or conditions to classify products having certain transaction trends as suitable for supply chain insurance. Furthermore, the market module 204 may be trained with additional data that the training engine 202 deems relevant for classifying products for supply chain insurance. For example, the market module 204 may be trained to associated negative events with transaction trends. Negative events may include, for example, inventory shortages, increased costs of a product, transportation and/or delivery delays, or any other event that is undesirable in the procurement of a product. The market module 204 may be trained to associate the negative events by establishing a likely relationship between the negative event and the anomalous transaction behavior based on inferences drawn from the underlying data. The market module 204 may then use the associated negative event and determine, based on inferences drawn from supply chain data, whether the at least one negative event could have been avoided under the existing supply chain structure. If the market module determines that the negative event could not have been avoided, the market module may classify a first product as suitable for a supply chain insurance model. Once trained, at 608, the market module 204 is applied to classify a first product as suitable for supply chain insurance.

In one example, a model training dataset for training a contract term module (e.g., volume module 206 or pricing module 208) is generated at 604. The contract term module training dataset may include terms of existing supply chain agreements for the first product. The contract term module may then be trained at 606 to determine one or more terms of a supply chain insurance contract for the first product by learning across terms that are common to supply chain agreements for the first product. Additionally, the contract term module training dataset may include additional data that is indicative of a desired term of a supply chain insurance contract. For example, if the contract term module is a volume module 206, the volume module training dataset may include transaction trends of the first product, inventory trends (e.g., data associated with inventory shortages) and any other data that is indicative of a desired volume term of the supply chain insurance contract. If the contract term module is a pricing module 208, the pricing module training dataset may include costs associated with procurement of the first product (e.g., production costs, inventory costs, shipping costs, and the like) as well as economic costs associated with, for example, inventory shortages of the first product. In some examples, the pricing module 208 may be trained using a pricing model that models economic costs to supply chain entities associated with the volume term of the supply chain insurance contract determined by the volume term module 206. Once trained, at 610, the contract term module is applied to determine one or more terms of a supply chain insurance contract that covers the first product classified at 608.

The method 600 continues with generating 612 a user platform (e.g., user platform 500) on a user interface of a computing device associated with a supply chain entity. The user platform presents information associated with the first product classified by the market module 204 at 608 as suitable for supply chain insurance and the one or more terms of the supply chain insurance contract for the product determined at 610. The user platform may then enable supply chain entities using the platform to provide input indicating that the supply chain entity is agreeable to the one or more terms of the supply chain insurance contract determined at 610. This input is received at 614. In some embodiments, the user input may be received by presenting a selectable prompt on user platform that requests feedback from supply chain entities for supply chain insurance information generated and presented on the platform. Supply chain entities may thereby be enabled to indicate whether the supply chain insurance information actually matches their interests. The training engine 202 may then parse this data and update, at 616, at least one of the model training datasets generated at 604 based on the user input.

In some embodiments, the input received at 614 may be actual interaction data and the training engine 202 may infer from this data that the information presented on the user platform is agreeable to the one or more terms determined at 610. For example, in some embodiments, the method 600 may further includes generating executable supply chain insurance contracts that include the one or more terms determined at 610 by the contract term module and generating at 612 the user platform that presents the generated supply chain insurance contract, where supply chain entities are enabled to accept the generated supply chain insurance contract. The training engine 202 may then update at least one of the model training datasets generated at 604 based on information that indicates the generated supply chain insurance contract has been accepted by supply chain entities on the user platform. In some embodiments, the method 600 may include receiving a bid from at least one of the supply chain entities for the supply chain insurance contract. The bid includes a proposed term of the supply chain insurance contract that is different from one of the terms determined by the contract term module at 610. The training engine 202 may then update at least one of the model training datasets generated at 604 based on information associated with the difference between the proposed term and the one of the terms determined by the contract term module. In some embodiments, the method 600 may include receiving a user input on the platform generated at 612, where the user input includes an existing supply chain agreement and a proposed modification to one of the terms of the existing supply chain agreement. A supply chain insurance contract may subsequently be generated based on the existing supply chain agreement and the proposed modification. The training engine 202 may then update at least one of the model training datasets generated at 604 based on the proposed modifications and the underlying agreement terms.

In embodiments where the method 600 further includes generating executable supply chain insurance contracts that include the one or more terms determined at 610 by the contract term module and presenting these contracts on the user platform, additional functionality may be provided. For example, the method 600 may include classifying subsets of supply chain entities that are suitable for supply chain insurance. Such a classification may be useful in recommending supply chain insurance contracts to entities on the platform. Such a classification may be performed by the market module 204, which may be trained as described above and with additional relevant data such as historical demand of the plurality of products and economic costs of inventory shortages of the plurality of products. Using the classified subset of entities, the method 600 may also include determining a volume of demand for supply chain insurance contracts. Such a determination may be useful in determining a number of supply chain insurance contracts covering the first product to present on the user platform. Such a determination may be performed by a demand module 212. The number of contracts generated may be based on the determined volume of demand, for example, the number may match the volume of demand. In other examples, number of generated supply chain insurance contracts is less than the volume of demand determined by the demand module. In these examples, the method 600 may also include determining a likelihood that the supply chain insurance contracts for the first product would be contemporaneously executed. Such a determination may be useful in ensuring that the demand could feasibly be serviced during a supply chain insurance event. Such a determination may be performed by the risk module 210. Furthermore, in some examples, the method 600 may include presenting pooled supply chain insurance contract on the user platform. Pooled supply chain insurance contracts include a group of supply chain entities that may pool their logistics under the contract. For example, a group of buyers of the first product that are located in nearby locations may pool their logistics under a single supply chain insurance contract. A pooling module 216 may be trained and applied to determine suitable groups of supply chain entities for the pooled supply chain insurance contract.

The computer systems and computer-implemented methods discussed herein may include additional, less, or alternate actions and/or functionalities, including those discussed elsewhere herein. The computer systems may include or be implemented via computer-executable instructions stored on non-transitory computer-readable media. The methods may be implemented via one or more local or remote processors, transceivers, servers, and/or sensors (such as processors, transceivers, servers, and/or sensors mounted on mobile computing devices, or associated with smart infrastructure or remote servers), and/or via computer executable instructions stored on non-transitory computer-readable media or medium.

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps”, or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, the term “database” may refer to either a body of data, a relational database management system (RDBMS), or to both. A database may include any collection of data including hierarchical databases, relational databases, flat file databases, object-relational databases, object oriented databases, and any other structured collection of records or data that is stored in a computing system. The above examples are for example only, and thus are not intended to limit in any way the definition and/or meaning of the term database. Examples of RDBMS's include, but are not limited to including, Oracle® Database, My SQL, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif).

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

In one embodiment, a computer program is provided, and the program is embodied on a computer readable medium. In an exemplary embodiment, the system is executed on a single computer system, without requiring a connection to a sever computer. In a further embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality. In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

As used herein, a processor may include any programmable system including systems using micro-controllers, reduced instruction set circuits (RISC), application specific integrated circuits (ASICs), logic circuits, and any other circuits or processor capable of executing the functions described herein.

As described above, the systems and methods described herein may use machine learning, for example, for pattern recognition and/or predictive modeling. That is, machine learning algorithms may be used by SCI server 102 to enable SCI server 102 to function as described herein. Accordingly, the systems and methods described herein may use machine learning algorithms for both pattern recognition and predictive modeling.

The patent claims at the end of this document are not intended to be construed under 35 U.S.C. § 112(f) unless traditional means-plus-function language is expressly recited, such as “means for” or “step for” language being expressly recited in the claim(s).

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A supply chain insurance computer system comprising at least one processor and a memory in communication with the at least one processor, the memory comprising computer-executable instructions stored therein, the computer-executable instructions being executable to cause the at least one processor to:
retrieve, from at least one database, data associated with procurement of a plurality of products, the data comprising transaction records and supply chain agreements for the plurality of products;
generate, from the retrieved data, a first model training dataset for a market module implemented by a machine learning engine, wherein the first model training dataset comprises transaction trends of the plurality of products;
train, using the first model training dataset, the market module to classify a suitability of each product for supply chain insurance based on the transaction trends;
apply the market module to classify a first product of the plurality of products as suitable for supply chain insurance;
generate, from the retrieved data, a second model training dataset for a contract term module implemented by the machine learning engine, wherein the second model training dataset comprises terms of supply chain agreements for the first product;
train, using the second model training dataset, the contract term module to determine terms of a supply chain insurance contract for the first product;
apply the contract term module to determine one or more terms of the supply chain insurance contract;
generate a user platform on a user interface of a computing device associated with a supply chain entity, wherein the user platform presents information associated with the first product classified by the market module and the one or more terms of the supply chain insurance contract for the first product;
receive, from the computing device associated with the supply chain entity, a user input that indicates whether the supply chain entity is agreeable to the one or more terms of the supply chain insurance contract; and
update at least one of the first model training dataset and the second model training dataset based on the user input.

2. The supply chain insurance computer system in accordance with claim 1, wherein the at least one processor is further configured to:
generate, from the retrieved data, the second model training dataset for a volume term module implemented by the machine learning engine, wherein the second model training dataset comprises volume terms of supply chain agreements for the first product and information associated with inventory shortages of the first product;
train, using the second model training dataset, the volume term module to determine a volume term of a supply chain insurance contract for the first product; and
apply the volume term module to determine one or more volume terms of the supply chain insurance contract.

3. The supply chain insurance computer system in accordance with claim 2, wherein the at least one processor is further configured to:
generate, from the retrieved data, a third model training dataset for a pricing term module implemented by the machine learning engine, wherein the third model training dataset comprises pricing terms of supply chain agreements for the first product and information associated with historical costs of procurement of the first product;
train, using the third model training dataset, the pricing term module to determine a pricing term of a supply chain insurance contract for the first product; and
apply the pricing term module to determine a pricing term of the supply chain insurance contract.

4. The supply chain insurance computer system in accordance with claim 3, wherein the pricing term module is trained with at least one pricing model that models economic costs to supply chain entities associated with the volume term of the supply chain insurance contract determined by the volume term module.

5. The supply chain insurance computer system in accordance with claim 3, wherein the pricing term module is trained with at least one pricing model that models economic costs to supply chain entities associated with inventory shortages of the first product.

6. The supply chain insurance computer system in accordance with claim 1, wherein the at least one processor is further configured to:
generate an executable supply chain insurance contract that includes the one or more terms determined by the contract term module; and
present the generated supply chain insurance contract on the user platform, wherein supply chain entities are enabled to accept the generated supply chain insurance contract.

7. The supply chain insurance computer system in accordance with claim 6, wherein the at least one processor is further configured to update at least one of the first model training dataset and the second model training dataset based on information that indicates the generated supply chain insurance contract has been accepted by supply chain entities on the user platform.

8. The supply chain insurance computer system in accordance with claim 6, wherein the at least one processor is further configured to:
receive a bid from at least one of the supply chain entities for the supply chain insurance contract, wherein the bid includes a proposed term of the supply chain insurance contract that is different from one of the terms determined by the contract term module; and
update the second model training dataset based on information associated with the difference between the proposed term and the one of the terms determined by the contract term module.

9. The supply chain insurance computer system in accordance with claim 1, wherein the at least one processor is further configured to:
receive a second user input that includes an existing supply chain agreement and a proposed modification to one of the terms of the existing supply chain agreement; and
generate a supply chain insurance contract based on the existing supply chain agreement and the proposed modification.

10. The supply chain insurance computer system in accordance with claim 9, wherein the at least one processor is further configured to update at least one of the first model training dataset and the second model training dataset based on the second user input.

11. The supply chain insurance computer system in accordance with claim 1, wherein the at least one processor is further configured to:
retrieve, from the at least one database, data comprising information associated with historical demand of the plurality of products and economic costs of inventory shortages of the plurality of products;
generate the first model training dataset to further comprise the information associated with historical demand of the plurality of products and economic costs of inventory shortages of the plurality of products;
train, using the first model training dataset, the market module to classify a subset of supply chain entities suitable for supply chain insurance contracts covering the first product; and
apply the market module to classify the subset of supply chain entities for the first product.

12. The supply chain insurance computer system in accordance with claim 11, wherein the at least one processor is further configured to:
generate, from the retrieved data and the classified subset of supply chain entities, a fourth model training dataset for a demand module implemented by the machine learning engine;
train, using the fourth model training dataset, the demand module to determine a volume of demand for supply chain insurance contracts for the first product;
apply the demand module to determine the volume of demand for supply chain insurance contracts for the first product;
generate a number of executable supply chain insurance contracts that include the one or more terms determined by the contract term module, wherein the number of contracts generated is based on the determined volume of demand; and
present the number of generated supply chain insurance contracts on the user platform, wherein supply chain entities are enabled to accept one or more of the generated supply chain insurance contracts.

13. The supply chain insurance computer system in accordance with claim 12, wherein the at least one processor is further configured to:
retrieve, from the at least one database, data comprising information associated with supply chain insurance events for the first product;
generate, from the retrieved data and the volume of demand determined by the demand module, a fifth model training dataset for a risk module implemented by the machine learning engine;
train, using the fifth model training dataset, the risk module to determine a likelihood that the supply chain insurance contracts for the first product would be contemporaneously executed;
apply the risk module to determine the likelihood that the supply chain insurance contracts for the first product would be contemporaneously executed;
generate a number of executable supply chain insurance contracts that include the one or more terms determined by the contract term module, wherein the number of contracts is based on the determined volume of demand and the likelihood that the supply chain insurance contracts for the first product would be contemporaneously executed; and
present the number of generated supply chain insurance contracts on the user platform, wherein supply chain entities are enabled to accept one or more of the generated supply chain insurance contracts.

14. The supply chain insurance computer system in accordance with claim 12, wherein the number of generated supply chain insurance contracts is less than the volume of demand determined by the demand module.

15. The supply chain insurance computer system in accordance with claim 11, wherein the at least one processor is further configured to:
retrieve, from the at least one database, data comprising information associated with procurement logistics of the first product for the classified subset of supply chain entities;
generate, from the retrieved data, a sixth model training dataset for a pooling module implemented by the machine learning engine;
train, using the sixth model training dataset, the pooling module to determine a group of supply chain entities for a pooled supply chain insurance contract;
apply the pooling module to determine the group of supply chain entities for the pooled supply chain insurance contract;
generate the pooled supply chain insurance contract that includes the one or more terms determined by the contract term module and the group of supply chain entities; and
present the pooled supply chain insurance contract on the user platform, wherein supply chain entities included in the group of supply chain entities are enabled to accept pooled supply chain insurance contract.

16. A computer-implemented method, the method implemented using a computing device including a processor in communication with at least one database, said method comprising:
retrieving, from the at least one database, data associated with procurement of a plurality of products, the data comprising transaction records and supply chain agreements for the plurality of products;
generating, from the retrieved data, a first model training dataset for a market module implemented by a machine learning engine, wherein the first model training dataset comprises transaction trends of the plurality of products;
training, using the first model training dataset, the market module to classify a suitability of each product for supply chain insurance based on the transaction trends;
applying the market module to classify a first product of the plurality of products as suitable for supply chain insurance;
generating, from the retrieved data, a second model training dataset for a contract term module implemented by the machine learning engine, wherein the second model training dataset comprises terms of supply chain agreements for the first product;
training, using the second model training dataset, the contract term module to determine terms of a supply chain insurance contract for the first product;
applying the contract term module to determine one or more terms of the supply chain insurance contract;
presenting, on a user platform generated on a user interface of a computing device associated with a supply chain entity, information associated with the first product classified by the market module and the one or more terms of the supply chain insurance contract for the first product;
receiving, from the computing device associated with the supply chain entity, a user input that indicates whether the supply chain entity is agreeable to the one or more terms of the supply chain insurance contract; and
updating at least one of the first model training dataset and the second model training dataset based on the user input.

17. The computer-implemented method in accordance with claim 16, further comprising:
generating an executable supply chain insurance contract that includes the one or more terms determined by the contract term module; and
presenting the generated supply chain insurance contract on the user platform, wherein supply chain entities are enabled to accept the generated supply chain insurance contract.

18. The computer-implemented method in accordance with claim 17, further comprising:
updating at least one of the first model training dataset and the second model training dataset based on information that indicates the generated supply chain insurance contract has been accepted by supply chain entities on the user platform.

19. The computer-implemented method in accordance with claim 17, further comprising:
receiving a bid from at least one of the supply chain entities for the supply chain insurance contract, wherein the bid includes a proposed term of the supply chain insurance contract that is different from one of the terms determined by the contract term module; and
updating the second model training dataset based on information associated with the difference between the proposed term and the one of the terms determined by the contract term module.

20. A non-transitory computer-readable storage medium that includes computer-executable instructions, wherein when executed by a computing device comprising at least one database and a processor in communication with the at least one database, the computer-executable instructions cause the processor to:
retrieve, from the at least one database, data associated with procurement of a plurality of products, the data comprising transaction records and supply chain agreements for the plurality of products;
generate, from the retrieved data, a first model training dataset for a market module implemented by a machine learning engine, wherein the first model training dataset comprises transaction trends of the plurality of products;
train, using the first model training dataset, the market module to classify a suitability of each product for supply chain insurance based on the transaction trends;
apply the market module to classify a first product of the plurality of products as suitable for supply chain insurance;
generate, from the retrieved data, a second model training dataset for a contract term module implemented by the machine learning engine, wherein the second model training dataset comprises terms of supply chain agreements for the first product;
train, using the second model training dataset, the contract term module to determine terms of a supply chain insurance contract for the first product;
apply the contract term module to determine one or more terms of the supply generate a user platform on a user interface of a computing device associated with a supply chain entity, wherein the user platform presents information associated with the first product classified by the market module and the one or more terms of the supply chain insurance contract for the first product;
receive, from the computing device associated with the supply chain entity, a user input that indicates whether the supply chain entity is agreeable to the one or more terms of the supply chain insurance contract; and
update at least one of the first model training dataset and the second model training dataset based on the user input.
